(19) United States
(12) Patent Application Publication
(10) Pub. No.: US 2026/0086728 A1
(43) Pub. Date: Mar. 26, 2026

(54) DATA MIGRATION BETWEEN DIFFERENT DOMAINS

(71) Applicant: DevRev, Inc., Palo Alto, CA (US)

(72) Inventors: Raško Pavlovic, Ljubljana (SI); Rok Preskar, Ljubljana (SI); Dragoslav Radin, Ljubljana (SI); Matic Conradi, Celje (SI)

(73) Assignee: DevRev, Inc., Palo Alto, CA (US)

(21) Appl. No.: 18/891,366

(22) Filed: Sep. 20, 2024

(51) Int. Cl. G06F 3/06

(52) U.S. Cl. CPC G06F 3/0647; G06F 3/0604; G06F 3/067

(57) ABSTRACT

Techniques for object matching and ontology alignment for data migration between different domain models are described. A plurality of objects from a plurality of source domains is received. Schema of the plurality of objects from the plurality of source domains corresponds to the plurality of source domain models. The schema of objects of the destination domain corresponds to a destination domain model. The plurality of source domain models is different from the destination domain model. The plurality of objects is converted into a predetermined data representation format. The converted plurality of objects is input to a machine learning model. The converted plurality of objects is transformed, using the machine learning model, to align with a destination domain model irrespective of quantity of object, object type, object attributes. The transformed plurality of objects is matched with a plurality of objects corresponding to the destination domain using the machine learning model.

### BACKGROUND

Various organizations use applications, such as Customer Relationship Management (CRM) based software applications, for various purposes. For instance, a CRM-based software application can be used to address issues raised by existing customers about products developed by the organization or services provided by the organization, provide technical support to the existing customers about the products and/or services of the organizations, handle customer sales using billing systems, and the like. The CRM-based software applications may transmit or receive data for various purposes, such as storing records about clients for a business, addressing problems raised by users corresponding to products or software applications of the business, expanding the customer base of the business, and the like.

In this regard, organizations that use the CRM-based software applications may have to connect the CRM-based software applications to various software applications, databases, Information Technology systems (IT systems), and one or more external CRM-based software applications. For example, the CRM-based software application may be connected to e-mail marketing platform, accounting software platform, sales data platform, and the like. This may ensure that the data are consistent and easily accessible throughout the organization. Accordingly, data corresponding to a client for a business may have to be migrated from a source CRM-based software application to a destination CRM-based software application. In other words, data may have to be migrated from a CRM-based platform, such as a Zendesk platform, to a CRM-based platform, such as a Dev rev platform.

### BRIEF DESCRIPTION OF DRAWINGS

The detailed description is provided with reference to the accompanying figures. In the figures, the leftmost digit(s) of a reference number identifies the figure in which the reference number first appears. The same numbers are used throughout the drawings to reference like features and components.

FIG. 1 illustrates a system for object matching and ontology alignment for data migration between different domain models, according to an example implementation of the present subject matter.

FIG. 2 illustrates a system for object matching and ontology alignment for data migration between different domain models, according to an example implementation of the present subject matter.

FIG. 3 illustrates a method for object matching and ontology alignment for data migration between different domain models, according to an example implementation of the present subject matter.

FIG. 4 illustrates a method for object matching and ontology alignment for data migration between different domain models, according to an example implementation of the present subject matter.

FIG. 5 illustrates a computing environment, implementing a non-transitory computer-readable medium for object matching and ontology alignment for data migration between different domain models, according to an example implementation of the present subject matter.

Throughout the drawings, identical reference numbers designate similar elements, but may not designate identical elements. The figures are not necessarily to scale, and the size of some parts may be exaggerated to illustrate the example shown with better clarity. Moreover, the drawings provide examples and/or implementations consistent with the description; however, the description is not limited to the examples and/or implementations provided in the drawings.

### DETAILED DESCRIPTION

Conventionally, organizations use Customer Relationship Management (CRM)-based software applications to manage customer and client relationships. The CRM-based software applications may be connected to various software applications, databases, Information Technology systems (IT systems), and one or more external CRM-based software applications for optimizing the data flow across various platforms to transmit or receive data. Accordingly, data corresponding to a product or a service may have to be migrated from a source CRM-based software application to a destination CRM-based software application.

Each of the product development or services in the CRM-based software applications produces a stream of events that describe some activity or change thereof. The events are unique to each unit, such as a product development unit or a service unit of the CRM-based software application. The events may reference one or more entities that span across the systems. A system of records includes events that are related to product development unit, services unit, or the like. In particular, the system of records includes a high volume of events. For instance, the system of records may include events of objects, such as to track work about a product of a company, various operations being performed within a company, to track issues on an application developed using development tools, to track bugs in the application developed, to track interactions with users of product of companies, to track tickets raised by users, to track sales leads, potential customers, and the like. The CRM-based software application from which the data is transferred may be referred to as the source domain. The CRM-based software application which receives the data may be referred to as the destination domain.

Generally, schema of the objects in the source domain may be different from schema of the objects in the destination domain. The schema of the objects in a domain may be referred to as the domain model. For instance, domain model in Zendesk platform may be different from the domain model in DevRev platform. Therefore, for a complete migration of the data, each of the objects from the source domain may have to be matched with corresponding objects in the destination domain. In this regard, a data transformation function may be generated for the object matching between the source domain model and the destination domain model. The process of creating a data transformation function that takes input data from one domain model and transforms into another domain model is referred to as ontology alignment.

Conventionally, the data transformation function is generated manually based on knowledge of the source domains and the destination domain. However, the manual process of generation of the transformation function is a cumbersome process. Especially given the volume of data for migration and disparate sources of data for migration, in some scenarios, manual generation of data transformation function to perform a complete migration of data may be difficult. Further, in some scenarios, the process of manually generating data transformation function and migration of the data is often time-consuming and prone to errors. For instance, during the transformation of the data, data from the source domains may require data clean up and reformatting. Without the process of data clean up and reformatting, unknown user data and potentially harmful user data from disparate source domains may prevent complete data migration and some data may not be migrated to the destination domain. The process of clean up and reformatting may require significant manual effort.

In some scenarios, data transformation function is generated using basic-level algorithms. The basic-level algorithms rely on lower-level language properties, such as semantic meaning of individual keys, data types, and other heuristics. The use of basic-level algorithms for the data transformation function generation and data migration are either slow or face significant limitations. Especially, given the large amount of data, data from disparate set of source domains, and complex data structures or complex source domains, even with the use of basic-level algorithms, the data migration may be difficult. Accordingly, the conventional data migrations processes are not coherent and accurate in maintaining the aligned data. Further, the conventional data migration processes are not scalable to handle large volume of data for migration while allowing significant variability in the input data format.

The present subject matter relates to techniques for object matching and ontology alignment for data migration between different domain models. The present subject matter quickly and efficiently understands the broader meaning of objects based on their textual representation and is significantly faster than conventional techniques. The present subject matter makes the process of data migration easier, coherent and accurate in maintaining the aligned data. Further, the present subject matter facilitates data migration of a large volume of data for migration while allowing significant variability in the input data format from disparate source domains.

In an implementation, a system for object matching and ontology alignment for data migration between different domain models may include a memory and a processing unit. The processing unit may be coupled to the memory. The processing unit may receive a plurality of objects from a plurality of source domains. The plurality of source domains may correspond to, for example, applications for customer-relationship management (CRM)-related support and/or CRM-related product development applications. Schema of the plurality of objects from the plurality of source domains corresponds to the plurality of source domain models. The plurality of the objects is to be migrated to a destination domain. The schema of objects of the destination domain may correspond to a destination domain model. The plurality of source domain models may be different from the destination domain model. Each of the plurality of objects has a plurality of data, each data corresponding to a data type, having a plurality of data attributes, and a plurality of data structures.

Further, the processing unit may convert the received plurality of objects into a predetermined data representation format. The predetermined data representation format may be, for example, JavaScript Object Notation (JSON) format. The processing unit may input the converted plurality of objects to a machine learning model. The machine learning model may be, for example, a Large Language Model (LLM). The processing unit may input the plurality of objects to the machine learning model for matching the transformed plurality of objects with the plurality of objects corresponding to the destination domain model.

The processing unit may transform, using the machine learning model, the converted plurality of objects to align with a destination domain model irrespective of quantity of objects, object type, object attributes. In an example, the machine learning model may be a trained machine learning model. In an example, the processing unit may fine-tune the trained machine learning model to enable the transformation of the plurality of objects and to enable the matching of the transformed plurality of objects.

In an example, the processing unit may fine-tune the trained machine learning model using a plurality of reference objects to transform the plurality of reference objects into the schema to align with the destination domain model and to match the transformed plurality of reference objects with corresponding objects corresponding to the destination domain. As a result of the fine-tuning of the trained machine learning model, the the processing unit may transform the plurality of objects and match, using the machine learning model, the transformed plurality of objects with a plurality of objects corresponding to the destination domain.

With the present subject matter, all the objects from a plurality of source domain models can be migrated to the destination domain model. The present subject matter uses LLM for ontology alignment and matching of objects between source domains and the destination domain. In particular, the present subject matter uses fine-tuned LLM for the object matching and ontology alignment between source domain models and a destination domain model. Therefore, the present subject matter facilitates quick and efficient understanding of the broader meaning of objects from the source domain models based on their textual representation. Accordingly, the present subject matter enables quick, efficient, robust, error-free, and complete migration of data from the source domain models to the destination domain model irrespective of the quantity of data, complexity of the data, and the complexity of the source domain models. With the present subject matter, the generation of the data transformation function and the process of data migration is easier. The present subject matter does not require manual efforts for the processes, such as data clean up and reformatting of the data from the source domain models. Further, unlike the conventional data migrations processes, the present subject matter is coherent and accurate in maintaining the aligned data between the source domain models and the destination domain model. The present subject matter facilitates scalability of the data migration process to handle large volume of data for migration while allowing significant variability in the input data format.

The present subject matter is further described with reference to the accompanying figures. Wherever possible, the same reference numerals are used in the figures and the following description to refer to the same or similar parts. It should be noted that the description and figures merely illustrate principles of the present subject matter. It is thus understood that various arrangements may be devised that, although not explicitly described or shown herein, encompass the principles of the present subject matter. Moreover, all statements herein reciting principles, aspects, and examples of the present subject matter, as well as specific examples thereof, are intended to encompass equivalents thereof.

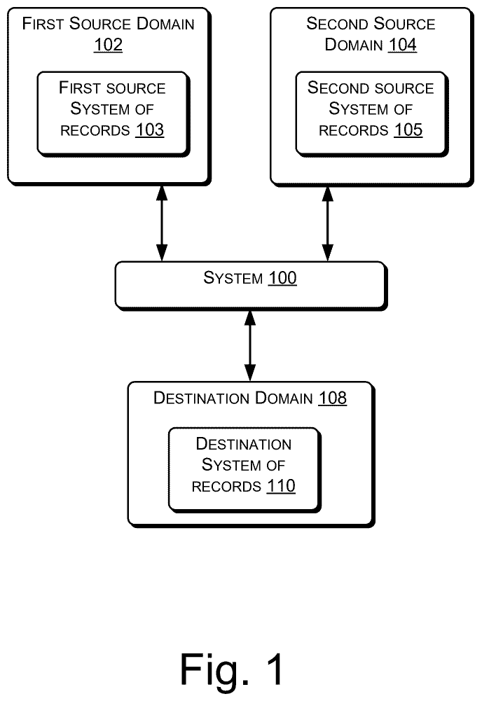

FIG. 1 illustrates a system 100 for object matching and ontology alignment for data migration between different domain models, according to an example implementation of the present subject matter. Domains, such as customer relationship management (CRM) domains, may have to transfer or receive data for different purposes, such as to address issues raised by existing customers about products or services provided corresponding to the CRM domains, to market about product or services provided by the CRM domains to prospective customers, and the like. In this regard, the CRM domains may be connected to various platforms, databases, one or more CRM domains, and the like.

The domains that are to transfer the data may be referred to as the source domains. In the example depicted herein, the source domain may include a first source domain 102 and a second source domain 104. The domain that is to receive the data may be referred to as the destination domain. In the example depicted herein, the destination domain may include the destination domain 108. The first source domain 102, the second source domain 104, and the destination domain 108 may be, for example, a CRM domain.

The first source domain 102 may be, for example, a CRM domain, such as Zendesk platform, JIRA platform, Hubspot, Salesforce platform, Freshdesk platform, and the like. The first source domain 102 may include a first source system of records 103. The first source system of records 103 may include events that are related to product development ecosystems, services ecosystems, or the like. Particularly, the first source system of records 103 may include a high volume of events. For instance, the first source system of records 103 may include events, such as to track various operations being performed within an organization that has deployed the first source domain 102, to track issues on an application developed using development tools by the organization that has deployed the first source domain 102, to track bugs in the application developed by the organization, to track interactions with users of product of organization, to track tickets raised by users of the organization, to track sales leads of the organization, potential customers, and the like. Each event may correspond to an object. Accordingly, the first source system of records 103 may include a plurality of objects. For instance, assume that the first source domain 102 is a Zendesk platform. The Zendesk platform may include events of objects in the source system of records corresponding to the Zendesk platform. In an example, the first source domain 102 may have to transfer data to the destination domain 108. For instance, the Zendesk platform may have to transfer data corresponding to ticket events raised by users registered in the Zendesk Platform. The users may correspond to a product developed by an organization that has deployed the Zendesk platform.

The second source domain 104 may be, for example, a CRM domain, such as Zendesk platform, JIRA platform, Hubspot, Salesforce platform, Freshdesk platform, and the like. The second source domain 104 may include a second source system of records 105. The second source system of records 105 may include events that are related to product development ecosystems, services ecosystems, or the like. Particularly, the second source system of records 105 may include a high volume of events. For instance, the second source system of records 105 may include events, such as to track various operations being performed within an organization that has deployed the second source domain 104, to track issues on an application developed using development tools by the organization that has deployed the second source domain 104, to track bugs in the application developed by the organization, to track interactions with users of product of organization, to track tickets raised by users of the organization, to track sales leads of the organization, potential customers, and the like. Each event may correspond to an object. Accordingly, the second source system of records 105 may include a plurality of objects. For instance, assume that the second source domain 104 is a Freshdesk platform. The Freshdesk platform may include events in the source system of records corresponding to the Freshdesk platform. In an example, the second source domain 104 may have to transfer data to the destination domain 108. The Freshdesk platform may have to transfer data of customers corresponding to a service provided by an organization that has deployed the Freshdesk platform.

The destination domain 108 may be, for example, a CRM system, such as a DevRev platform. The destination domain 108 may include a system of records 110 that are to include events corresponding to the destination domain 108. The events may be for example, correspond to tracking issues on an application developed using development tools, to tracking bugs in an application, to track interactions with users of product, to tracking tickets raised by users of the organization, to tracking sales leads of the organization, potential customers, events migrated from the source domains 102, 104, and the like. Each event may correspond to an object. Accordingly, the destination system of records 110 may include a plurality of objects.

In an example, as explained above, the data may have to be migrated from the first source system of records 103 to the destination system of records 110. Similarly, the data may have to be migrated from the second source system of records 105 to the destination system of records 110. For instance, assume that the organization may have to migrate data from the Zendesk platform and the Freshdesk platform to DevRev platform. The Zendesk platform may have to transfer data corresponding to ticket events as comments in DevRev platform. Similarly, the Freshdesk platform may have to transfer data corresponding to customers as contacts in DevRev platform. The schema of the objects in the source domains, such as the first source domain 102 and the second source domain 104, may be different from the schema of the objects in the destination domain 108. The schema of the objects corresponding to the first source domain 102 may be referred to as the first source domain model and the schema of the objects corresponding to the second source domain 104 may be referred to as the second source domain model. The schema of the objects in the destination domain 108 may be referred to as the destination domain model. Accordingly, for the complete data migration, the objects may have to be matched between the source domains 102, 104 and the destination domain 108.

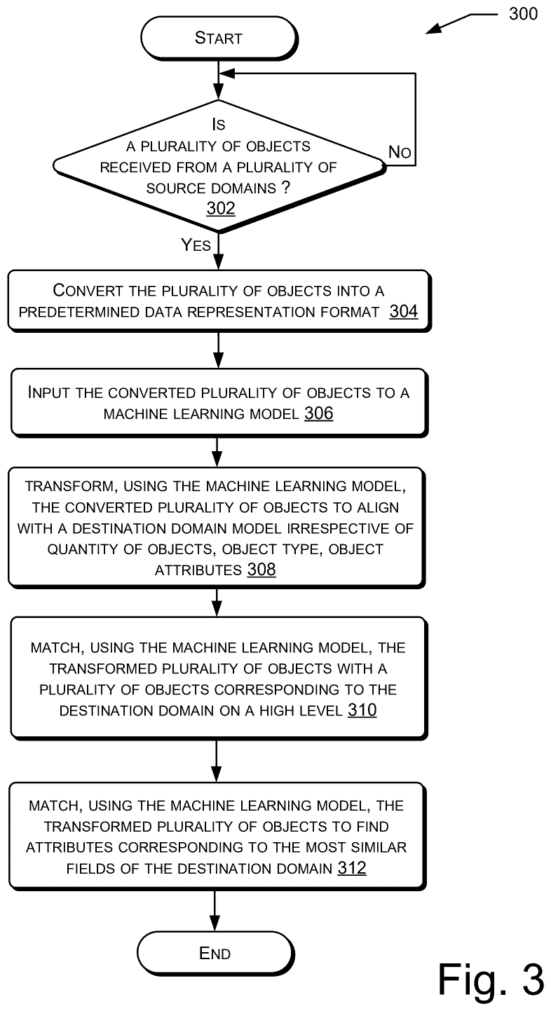

In this regard, the system 100 may facilitate the object matching and ontology alignment for data migration between different domain models. In other words, the system 100 may facilitate the object matching and ontology alignment for data migration between the source domain models and the destination domain model. The system 100 may be a computing device that has processing capabilities, such as a server, a desktop, a laptop, a tablet, a mobile phone, or the like. For instance, the system 100 may include, for example, a microprocessor, a microcomputer, a microcontroller, a digital signal processor, a central processing unit, a state machine, a logic circuitry, or a device that manipulates signals based on operational instructions. The system 100 may include a processing unit (not shown in FIG. 1) and a memory (not shown in FIG. 1). In an example, the system 100 may use a machine learning model, such as a Large Language Model (LLM) for the object matching and ontology alignment. The LLM may be a trained LLM. The LLM may be trained using may be provided with general knowledge text, such as news articles, blogs, articles from repository on the internet, posts from social media, and the like. Further, the LLM may be fine-tuned based on which the machine learning model may classify and map the type of objects from the source domains 102, 104 to align with the destination domain model using a plurality of reference objects, as will be explained with reference to FIG. 3.

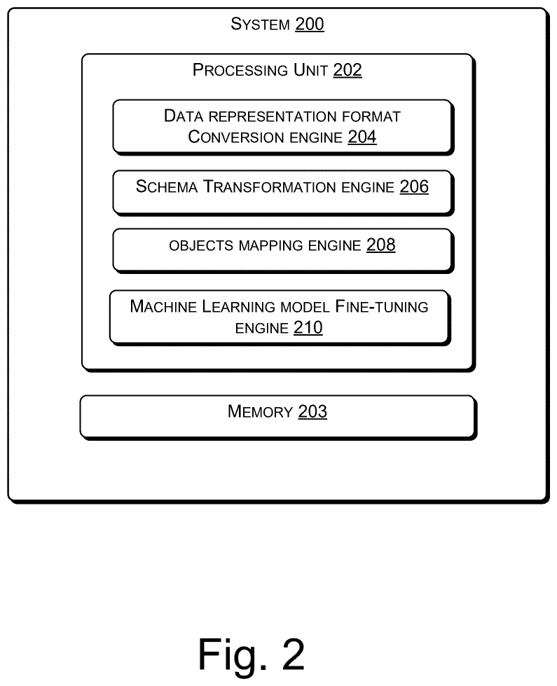

FIG. 2 illustrates a system 200 for object matching and ontology alignment for data migration between different domain models, according to an example implementation of the present subject matter. The system 200 may correspond to the system 100. The system 200 may include a processing unit 202 and a memory 203. Among other capabilities, the processing unit 202 may fetch and execute computer-readable instructions stored in the memory 203, such as a volatile memory or a non-volatile memory, of the system 200.

The processing unit 202 may run at least one operating system and other applications and services. The system 200 may also include an interface (not shown in FIG. 2). The processing unit 202, amongst other capabilities, may be configured to fetch and execute computer-readable instructions stored in the memory 203. The processing unit 202 may be implemented as one or more microprocessors, microcomputers, microcontrollers, digital signal processors, central processing units, state machines, logic circuitries, and/or any devices that manipulate signals based on operational instructions. The functions of the various elements shown in the figure, including any functional blocks labelled as “processing unit”, may be provided through the use of dedicated hardware as well as hardware capable of executing machine readable instructions.

When provided by the processing unit 202, the functions may be provided by a single dedicated processor, by a single shared processor, or by a plurality of individual processors, some of which may be shared. Moreover, explicit use of the term “processing unit” should not be construed to refer exclusively to hardware capable of executing machine readable instructions, and may implicitly include, without limitation, digital signal processor (DSP) hardware, network processor, application specific integrated circuit (ASIC), field programmable gate array (FPGA), read only memory (ROM) for storing machine readable instructions, random access memory (RAM), non-volatile storage. Other hardware, conventional and/or custom, may also be included.

The interface may include a variety of machine-readable instructions-based interfaces and hardware interfaces that allow the system 200 to interact with different entities, such as the source domains (not shown in FIG. 2), the destination platform (not shown in FIG. 2), and the data (not shown in FIG. 2). Further, the interface may enable the components of the system 200 to communicate with computing devices, web servers, and external repositories. The interface may facilitate multiple communications within a wide variety of networks and protocol types, including wireless networks, wireless Local Area Network (WLAN), Radio Access Network (RAN), satellite-based network, and the like.

The memory 203 may be coupled to the processing unit 202 and may, among other capabilities, provide data and instructions for generating different requests. The memory 203 can include any computer-readable medium known in the art including, for example, volatile memory, such as static random-access memory (SRAM) and dynamic random-access memory (DRAM), and/or non-volatile memory, such as read only memory (ROM), erasable programmable ROM, flash memories, hard disks, optical disks, and magnetic tapes.

Further, the system 200 can include one or more engines 204-208. The engines 204-210 may include routines, programs, objects, components, data structures, and the like, which perform particular tasks or implement particular abstract data types. Further, the engines 204-210 may be implemented in hardware, instructions executed by a processing unit, or by a combination thereof.

In an implementation, the engines 204-210 may be machine-readable instructions which, when executed by the processing unit 202, perform any of the described functionalities. The machine-readable instructions may be stored on an electronic memory device, hard disk, optical disk or other machine-readable storage medium or non-transitory medium. In one implementation, the machine-readable instructions can also be downloaded to the storage medium via a network connection. The engines 204-210 may perform different functionalities. The engines 204-210 may include a data representation format conversion engine 204, schema transformation engine 206, objects mapping engine 208, and machine learning model fine-tuning engine 210.

The data representation format conversion engine 204 may convert a plurality of objects received from a plurality of source domains. The plurality of source domains may correspond to the first source domain 102 (not shown in FIG. 2) and the second source domain 104 (not shown in FIG. 2). The schema of the plurality of objects from the plurality of source domains corresponds to the plurality of source domain models. The plurality of source domain models may correspond to schema of the objects from the first source domain 102 and the second source domain 104. The plurality of objects from the plurality of source domains may have to be migrated to the destination domain 108 (not shown in FIG. 2). The schema of objects of the destination domain corresponds to a destination domain model. The plurality of source domain models may be different from the destination domain model.

Upon receiving the plurality of objects from the first source domain 102 and the plurality of objects from the second source domain 104, the data representation format conversion engine 204 may convert the plurality of objects into a predetermined data representation format. In an example, the predetermined data representation format may be a JavaScript Object Notation (JSON) format. The conversion into JSON format may enable easy classification of a type of the object.

In an example, the LLM may be a trained LLM. For instance, for the training, the LLM may be provided with general knowledge text, such as news articles, blogs, articles from repository on the internet, posts from social media, and the like. The machine learning model fine-tuning engine 210 may fine-tune the trained LLM based on which the LLM may learn to classify and match objects with the schema of the destination domain model. For the fine-tuning the LLM, a plurality of reference objects specific to the source domain models may be provided to the LLM. The plurality of reference objects may be provided with the reference labels for matching the plurality of reference objects with the destination domain. The reference labels may correspond to schema of the destination model.

The schema transformation engine 206 may input the converted plurality of objects in the JSON format to a machine learning model. In an example, the machine learning model may be an LLM. Hereinafter, the machine learning model will be explained with reference to LLM. The schema transformation engine 206 may use the LLM to transform the converted plurality of objects in the JSON format into schemas to align with the destination domain model irrespective of quantity of objects, object type, object attributes, and the like.

In an example, the schema transformation engine 206 may facilitate the transformation of the plurality of objects using the fine-tuned LLM to align with the destination domain model. The schema transformation engine 206 may use the fine-tuned LLM to transform objects to align with the schema of the destination domain model. As a result of use of the fine-tuned LLM, the schema transformation engine may transform the type of objects received from the source domains 102, 104 to align with the destination domain model.

The objects mapping engine 208 may match the transformed plurality of objects with a plurality of objects corresponding to the destination domain model. The matching of the plurality of objects may be performed using the fine-tuned LLM. As mentioned earlier, as a result of the fine-tuning of the trained LLM, the objects mapping engine 208 may match the type of objects received from the source domains 102, 104 to align with the destination domain model. Therefore, with the use of fine-tuned LLM, the type of objects received from the source domains 102, 104 may be classified and mapped to align with the destination domain model.

FIG. 3 illustrates a method 300 for object matching and ontology alignment for data migration between different domain models, according to an example implementation of the present subject matter. The order in which the method 300 is described is not intended to be construed as a limitation, and any number of the described method blocks may be combined in any order to implement the method 300, or an alternative method. Furthermore, the method 300 may be implemented by processor(s) or computing device(s) through any suitable hardware, non-transitory machine-readable instructions, or a combination thereof.

It may be understood that steps of the method 300 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. In an example, the method 300 may be performed by the system 100 or the system 200. Particularly, the method 300 may be performed by the processing unit, such as the processing unit 202.

At step 302, it may be determined if a plurality of data objects is received from the plurality of source domains. The plurality of source domains may correspond to a first source domain and a second source domain. Schema of the plurality of objects from the plurality of source domains corresponds to the plurality of source domain models. The plurality of source domain models may correspond to the schema of a first source domain and the schema of a second source domain. The plurality of data objects may correspond to the data migration from the source domains to the destination domain. In particular, the data may have to be migrated from source system of records, such as the first source system of records and the second source system of records, to the destination system of records. The schema of objects of the destination domain corresponds to a destination domain model. The plurality of source domain models may be different from the destination domain model. The first source domain may correspond to the first source domain 102. The second source domain may correspond to the second source domain 104. The destination domain may correspond to the destination domain 108. The first source system of records may correspond to the first source system of records 103. The second source system of records may correspond to the second source system of records 105. The destination system of records may correspond to the destination system of records 110. For instance, assume that the first source domain may correspond to Zendesk platform and the second source domain may correspond to Freshdesk platform. Further, assume that the destination domain may correspond to the DevRev platform. Yet further, assume that the objects, for example, administration users from the Zendesk platform may have to be migrated to the DevRev platform as development users and the objects, such as customers, from the Freshdesk platform may have to be migrated as contacts to the DevRev platform. In this regard, the schema of the data objects corresponding to the administration users from the Zendesk platform may be different from the schema of the data object, for example, development users, in DevRev platform. Similarly, the schema of the objects, such as customers, in Freshdesk platform may be different from the schema of the objects, contacts, in the DevRev platform. Therefore, for the data migration, the objects from the Zendesk platform and the Freshdesk platform may be received from the Zendesk platform and the Freshdesk platform.

If, at step 302, it is determined that the plurality of objects is not received from the plurality of source domain models, the method 300 may repeat the step 302. On the other hand, if it is determined that the plurality of objects is received from the plurality of domain models, the method 300 may proceed to step 304.

At step 304, the plurality of objects may be converted into a predetermined data representation format. The predetermined data representation format may be, for example, JSON. For instance, the “administration users” objects from the Zendesk platform and the “customers” objects from the Freshdesk platform may be received and converted into JSON representation. Generally, predetermined data representation format may be a format that corresponds to the format that was used in the trained LLM. In an example, JSON may be the format used for serializing data in training the LLM. Therefore, to use the trained LLM, the JSON format may be used for transformation and the matching of the objects. In other examples, the predetermined data representation formats may include Extensible Markup Language (XML), Yet Another Markup Language (YAML), or Tom's Own Markup Language (TOML).

At step 306, the converted plurality of objects may be input to the machine learning model. The machine learning model may be, for example, LLM. For instance, the “administration users” objects from the Zendesk platform in the JSON format and the “customers” objects from the Freshdesk platform in the JSON format may be input to the LLM.

At step 308, the converted plurality of objects may be transformed into schemas to align with a destination domain model. The conversion may be performed by the LLM and may be performed irrespective of quantity of objects, the object type, and/or object attributes.

In this regard, to facilitate the transformation, the LLM may generate a data transformation function. Further, the LLM may transform the converted plurality of objects using the data transformation function. In this regard, the LLM may be a trained LLM. The LLM may be trained using general knowledge text, such as news articles, blogs, articles from repository on the internet, posts from social media, and the like.

The trained LLM may be fine-tuned to classify and match the transformed plurality of objects from the source domain models to find attributes corresponding to the most similar fields of the destination domain. For the fine-tuning the trained LLM, a plurality of reference objects specific to the source domain models may be provided to the LLM. The plurality of reference objects may be provided with corresponding reference labels for classification and matching of the plurality of reference objects with the destination domain. In other words, the LLM may be provided with a plurality of reference objects and corresponding reference labels. Each of the plurality of reference objects may have a schema of source domain. The reference labels may correspond to objects with a schema of the destination domain. By providing reference labels, classification and matching of the plurality of reference objects with the destination domain may be performed. The plurality of reference objects may be chosen so that the LLM may respond to a predefined set of specific objects upon the training.

For instance, the “administration users” objects from the Zendesk platform in the JSON format may be transformed to align with the Dev rev domain model. Similarly, the “customers” objects from the Freshdesk platform in the JSON format may be transformed to align with the Dev rev domain model. In particular, the schema of the Zendesk platform corresponding to administration user may include “user Identification”, “full name”, and “mail”. On the other hand, the Dev Rev domain model corresponding to the “administration user” may include “identification” instead of “user identification, “name” instead of “full name”, and “e-mail” instead of “mail”. Therefore, the objects corresponding to “administration users” of the Zendesk platform may be transformed to align with the DevRev domain model.

At step 310, the transformed plurality of objects may be matched with the corresponding plurality of objects to the destination domain on a high level using the LLM. For instance, the data objects corresponding to “administration users” may be matched on a high level to corresponding objects of the DevRev platform. In other words, the objects corresponding to the “administration users” in the Zendesk platform may be matched with “administration users” of the DevRev platform. Similarly, the objects corresponding to “customers” in Freshdesk platform may be matched with “contacts” in DevRev platform. For instance, objects corresponding to “administration users” of the Zendesk platform, such as user objects, work items, tags, comments, and the like may have some attributes that are same. For example, comment object and work item object may have same author. Therefore, it may be difficult to directly match attributes. Therefore, the transformed plurality of objects from the Zendesk platform that match with corresponding DevRev objects may have to be identified. This is referred to as high level matching. Generally, the high level matching may not be a trivial process as objects generally do not have a name. Therefore, the meaning of the objects must be inferred from schema of the objects. Further, an object with an equivalent meaning must be identified on DevRev platform. By the use of fine-tuned LLM, the meaning of the schema is inferred from the objects of the source domains and matched with objects of the destination domain.

At step 312, the transformed plurality of objects may be matched to find attributes corresponding to most similar object attributes of the destination domain. For instance, the object attributes corresponding to the “administration user” in the Zendesk platform may be matched with the most relevant object attributes corresponding to the “development users” in the DevRev platform. Similarly, the object attributes corresponding to the “customers” in the Freshdesk platform may be matched with the most relevant object attributes corresponding to “contacts”in DevRev platform.

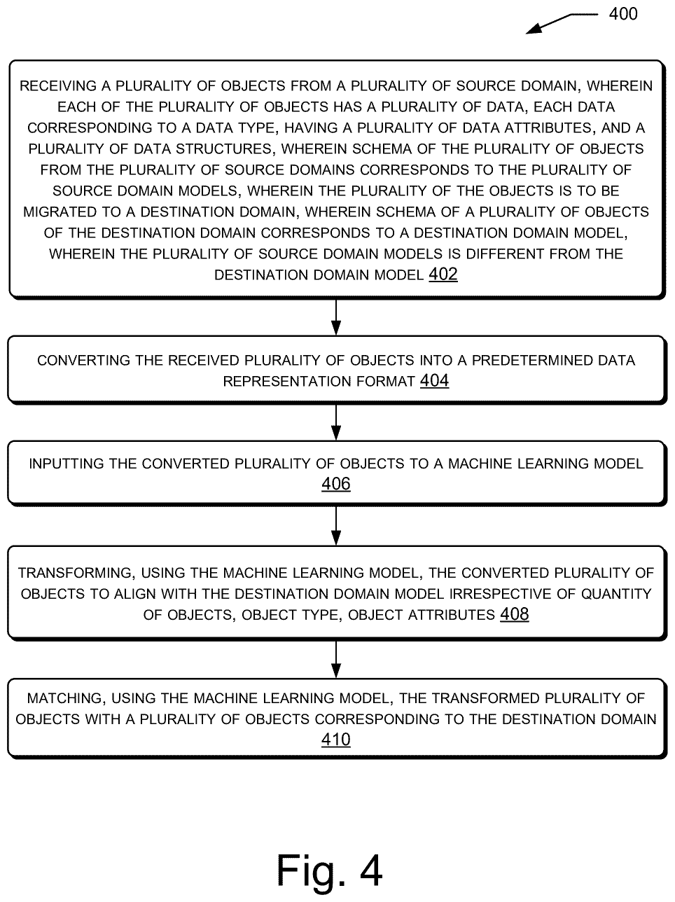

FIG. 4 illustrates a method 400 for a method for object matching and ontology alignment for data migration between different domain models, according to an example implementation of the present subject matter. The order in which the method 400 is described is not intended to be construed as a limitation, and any number of the described method blocks may be combined in any order to implement the method 400, or an alternative method. Furthermore, the method 400 may be implemented by processor(s) or computing device(s) through any suitable hardware, non-transitory machine-readable instructions, or a combination thereof.

It may be understood that steps of the method 400 may be performed by programmed computing devices and may be executed based on instructions stored in a non-transitory computer readable medium. The non-transitory computer readable medium may include, for example, digital memories, magnetic storage media, such as magnetic disks and magnetic tapes, hard drives, or optically readable digital data storage media. The method 400 may be performed by the system 100 or the system 200.

At step 402, a plurality of objects from a plurality of source domains may be received. Each of the plurality of objects has a plurality of data, each data corresponding to a data type, having a plurality of data attributes, and a plurality of data structures. Schema of the plurality of objects from the plurality of source domains may correspond to the plurality of source domain models. The plurality of the objects may be migrated to a destination domain. The schema of objects of the destination domain corresponds to a destination domain model. The plurality of source domain models is different from the destination domain model. The plurality of source domains may correspond to the first source domain 102 and the second source domain 104. The destination domain may correspond to the destination domain 108.

At step 404, the received plurality of objects may be converted into a predetermined data representation format. The predetermined data representation format may be, for example, JSON format. At step 406, the converted plurality of objects may be input to a machine learning model. The machine learning model may be, for example, LLM.

At step 408, the converted plurality of objects may be transformed to align with a destination domain model irrespective of quantity of objects, object type, object attributes. The transformation of the converted plurality of objects may be performed using the machine learning model. In an example, the machine learning model may be a trained machine learning model trained using using a plurality of general knowledge references, such as to transform the plurality of reference objects into the schemas to align with the destination domain model. Prior to the training, the method 400 may include converting the plurality of reference objects into the predetermined representation format, such as the JSON format. In an example, the method 400 may include fine-tuning the machine learning model to enable the transformation corresponding to a predefined set of objects from the plurality of objects.

At step 410, the transformed plurality of objects may be matched with a plurality of objects corresponding to the destination domain. The matching may be done using the trained machine learning model. using general knowledge text, such as news articles, articles from repository on the internet, posts from social media, and the like. The trained machine learning model may be fine-tuned to learn to classify and map objects with the schema of the destination domain model. As a result of the fine-tuning of the trained machine learning model, the machine learning model may classify the type of objects received from the source domains to align with the destination domain model. For the fine-tuning the machine learning model, a plurality of reference objects specific to the source domain models may be provided to the trained machine learning model. The plurality of reference objects may be provided with the reference labels for matching the plurality of reference objects with the destination domain. The reference labels may correspond to schema of the destination model. As mentioned earlier, as a result of fine-tuning of the trained machine learning model, the LLM may transform and match the objects received from the source domains with the destination domain model.

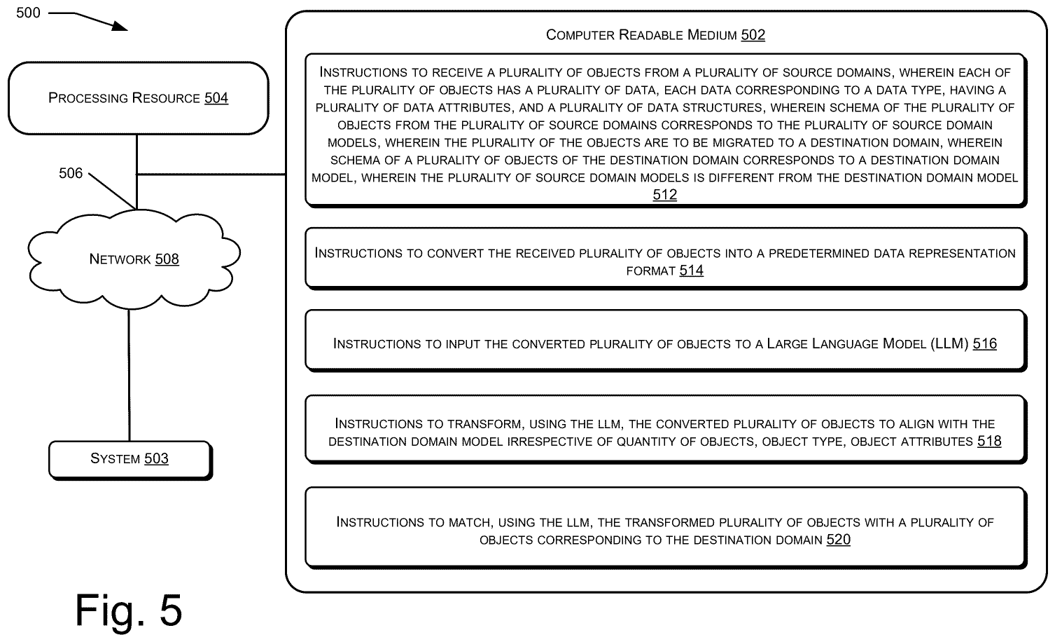

FIG. 5 illustrates a computing environment 500, implementing a non-transitory computer-readable medium for object matching and ontology alignment for data migration between different domain models, according to an example implementation of the present subject matter. In an example, the non-transitory computer-readable medium 502 may be utilized by the system 503. The system 503 may correspond to the system 100 or the system 200. The system 503 may be implemented in a public networking environment or a private networking environment. In an example, the computing environment 500 may include a processing resource 504 communicatively coupled to the non-transitory computer-readable medium 502 through a communication link 506.

In an example, the processing resource 504 may be implemented in a device, such as the system 503. The non-transitory computer-readable medium 502 may be, for example, an internal memory device of the system 503 or an external memory device. In an implementation, the communication link 506 may be a direct communication link, such as any memory read/write interface. In another implementation, the communication link 506 may be an indirect communication link, such as a network interface. In such a case, the processing resource 504 may access the non-transitory computer-readable medium 502 through a network 508. The network 508 may be a single network or a combination of multiple networks and may use a variety of different communication protocols. The processing resource 504 and the non-transitory computer-readable medium 502 may also be communicatively coupled to the system 503 over the network 508.

In an example implementation, the non-transitory computer-readable medium 502 includes a set of computer-readable instructions to transform data forms in schemas for data transfer between different platforms. The set of computer-readable instructions can be accessed by the processing resource 504 through the communication link 506.

Referring to FIG. 5, in an example, the non-transitory computer-readable medium 502 includes instructions 512 to receive a plurality of objects from a plurality of source domain models. Each of the plurality of objects has a plurality of data. Each data may correspond to a data type, having a plurality of data attributes, and a plurality of data structures. Schema of the plurality of objects from the plurality of source domains may correspond to the plurality of source domain models. The plurality of the objects may be migrated to a destination domain. The schema of objects of the destination domain corresponds to a destination domain model. The plurality of source domain models is different from the destination domain model. The plurality of source domains may correspond to the first source domain 102 and the second source domain 104. The destination domain may correspond to the destination domain 108.

In an example, the non-transitory computer-readable medium 502 includes instructions to receive the plurality of objects from at least one of applications for CRM-related support and customer-relationship management CRM-related product development applications.

The non-transitory computer-readable medium 502 includes instructions 514 to convert the received plurality of objects into a predetermined data representation format. The predetermined data representation format may be, for example, JSON format.

The non-transitory computer-readable medium 502 includes instructions 516 to input the converted plurality of objects to an LLM. The non-transitory computer-readable medium 502 includes instructions 518 to transform, using the LLM, the converted plurality of objects to align with a destination domain model irrespective of quantity of objects, object type, object attributes. The destination domain model may correspond to schema of the objects of the destination domain, such as the destination domain 108.

The non-transitory computer-readable medium 502 includes instructions 520 to match, using the LLM, the transformed plurality of objects with a plurality of objects corresponding to the destination domain. In an example, the non-transitory computer-readable medium 502 includes instructions to fine-tune the LLM using a plurality of reference objects to transform the plurality of reference objects to align with the destination domain model and to match the plurality of reference objects with the destination domain model. In other words, the non-transitory computer-readable medium 502 includes instructions to fine-tune the LLM to enable the transformation corresponding to a predefined set of objects from the plurality of objects and to enable the matching of the predefined set of objects from the plurality of objects with the destination domain models. The LLM may be a trained LLM trained with general knowledge text, such as news articles, blogs, articles from repository on the internet, posts from social media, and the like.

In an example, prior to the fine-tuning, the non-transitory computer-readable medium 502 includes instructions to convert the plurality of reference objects into the predetermined data representation format. The non-transitory computer-readable medium 502 includes instructions to input the plurality of objects to the machine learning model for matching the transformed plurality of objects with the plurality of objects corresponding to the destination domain model.

With the present subject matter, all the objects from a plurality of source domain models can be migrated to the destination domain model. The present subject matter uses LLM for ontology alignment and matching of objects between source domains and the destination domain. In particular, the present subject matter uses fine-tuned LLM for the object matching and ontology alignment between source domain models and a destination domain model. Therefore, the present subject matter facilitates quick and efficient understanding of the broader meaning of objects from the source domain models based on their textual representation. Accordingly, the present subject matter enables quick, efficient, robust, error-free, and complete migration of data from the source domain models to the destination domain model irrespective of the quantity of data, complexity of the data, and the complexity of the source domain models. With the present subject matter, the generation of the data transformation function and the process of data migration is easier. The present subject matter does not require manual efforts for the processes, such as data clean up and reformatting of the data from the source domain models. Further, unlike the conventional data migrations processes, the present subject matter is coherent and accurate in maintaining the aligned data between the source domain models and the destination domain model. The present subject matter facilitates scalability of the data migration process to handle large volume of data for migration while allowing significant variability in the input data format.

Although examples and implementations of present subject matter have been described in language specific to structural features and/or methods, it is to be understood that the present subject matter is not necessarily limited to the specific features or methods described. Rather, the specific features and methods are disclosed and explained in the context of a few example implementations of the present subject matter.

What is claimed is:

1. A system for object matching and ontology alignment for data migration between different domain models, the system comprising:
a memory;
a processing unit coupled to the memory, wherein the processing unit is to:
receive a plurality of objects from a plurality of source domains, wherein each of the plurality of objects has a plurality of data, each data corresponding to a data type, having a plurality of data attributes, and a plurality of data structures, wherein schema of the plurality of objects from the plurality of source domains corresponds to a plurality of source domain models, wherein the plurality of objects is to be migrated to a destination domain, wherein schema of a plurality of objects of the destination domain corresponds to a destination domain model, wherein the plurality of source domain models is different from the destination domain model;
convert the received plurality of objects into a predetermined data representation format;
input the converted plurality of objects to a machine learning model;
transform, using the machine learning model, the converted plurality of objects to align with the destination domain model irrespective of quantity of object, object type, and object attributes; and
match, using the machine learning model, the transformed plurality of objects with the plurality of objects corresponding to the destination domain.

2. The system of claim 1, wherein the machine learning model is a Large language Model (LLM).

3. The system of claim 1, wherein the predetermined data representation format comprises JavaScript Object Notation (JSON).

4. The system of claim 1, wherein the machine learning model is a trained machine learning model and wherein the processing unit is to fine-tune the trained machine learning model to enable the transformation of the plurality of objects and to enable the matching of the transformed plurality of objects.

5. The system of claim 4, wherein the processing unit is to fine-tune the trained machine learning model using a plurality of reference objects to transform the plurality of reference objects into the schema to align with the destination domain model and to match the transformed plurality of reference objects with corresponding objects corresponding to the destination domain.

6. The system of claim 1, wherein the processing unit is to input the plurality of objects to the machine learning model for matching the transformed plurality of objects with the plurality of objects corresponding to the destination domain model.

7. The system of claim 1, wherein the plurality of source domains corresponds to at least one of: applications for customer-relationship management (CRM)-related support and CRM-related product development applications.

8. A method for object matching and ontology alignment for data migration between different domain models, the method comprising:
receiving a plurality of objects from a plurality of source domains, wherein each of the plurality of objects has a plurality of data, each data corresponding to a data type, having a plurality of data attributes, and a plurality of data structures, wherein schema of the plurality of objects from the plurality of source domains corresponds to a plurality of source domain models, wherein the plurality of the objects is to be migrated to a destination domain, wherein schema of a plurality of objects of the destination domain corresponds to a destination domain model, wherein the plurality of source domain models is different from the destination domain model;
converting the received plurality of objects into a predetermined data representation format;
inputting the converted plurality of objects to a machine learning model;
transforming, using the machine learning model, the converted plurality of objects to align with the destination domain model irrespective of quantity of objects, object type, and object attributes; and
matching, using the machine learning model, the transformed plurality of objects with the plurality of objects corresponding to the destination domain.

9. The method of claim 8, wherein the machine learning model is a Large language Model (LLM).

10. The method of claim 8, wherein the predetermined data representation format comprises JavaScript Object Notation (JSON).

11. The method of claim 8, wherein the machine learning model is a trained machine learning model, wherein the method comprises fine-tuning the trained machine learning model to enable the transformation of the plurality of objects and to enable the matching of the transformed plurality of objects.

12. The method of claim 11, comprising fine-tuning the trained machine learning model using a plurality of reference objects to transform the plurality of reference objects into the schema to align with the destination domain model and to match the transformed plurality of reference objects with corresponding objects corresponding to the destination domain.

13. The method of claim 11, wherein prior to the fine-tuning, the method comprises converting the plurality of reference objects into the predetermined data representation format.

14. A non-transitory computer-readable medium comprising instructions for object matching and ontology alignment for data migration between different domain models, the instructions being executable by a processing resource to:
receive a plurality of objects from a plurality of source domains, wherein each of the plurality of objects has a plurality of data, each data corresponding to a data type, having a plurality of data attributes, and a plurality of data structures, wherein schema of the plurality of objects from the plurality of source domains corresponds to a plurality of source domain models, wherein the plurality of the objects is to be migrated to a destination domain, wherein schema of a plurality of objects of the destination domain corresponds to a destination domain model, wherein the plurality of source domain models is different from the destination domain model;
convert the received plurality of objects into a predetermined data representation format;
input the converted plurality of objects to a Large Language Model (LLM);
transform, using the LLM, the converted plurality of objects to align with the destination domain model irrespective of quantity of objects, object type, and object attributes; and
match, using the LLM, the transformed plurality of objects with the plurality of objects corresponding to the destination domain.

15. The non-transitory computer-readable medium of claim 14, wherein the predetermined data representation format comprises JavaScript Object Notation (JSON).

16. The non-transitory computer-readable medium of claim 14, wherein the LLM is a trained LLM, and the instructions being executable by the processing resource to fine-tune the LLM to enable the transformation of the plurality of objects and to enable the matching of the transformed plurality of objects.

17. The non-transitory computer-readable medium of claim 16, the instructions being executable by the processing resource to fine-tune the LLM using a plurality of reference objects to transform the plurality of reference objects into the schema to align with the destination domain model and to match the transformed plurality of reference objects with corresponding objects corresponding to the destination domain.

18. The non-transitory computer-readable medium of claim 14, the instructions being executable by the processing resource to input the plurality of objects to the LLM for matching the transformed plurality of objects with the plurality of objects corresponding to the destination domain model.

19. The non-transitory computer-readable medium of claim 16, wherein prior to the training, the instructions being executable by the processing resource to convert the plurality of reference objects into the predetermined data representation format.

20. The non-transitory computer-readable medium of claim 14, the instructions being executable to receive the plurality of objects from at least one of: applications for customer-relationship management (CRM)-related support and CRM-related product development applications.
